(19) United States
(12) Patent Application Publication
(10) Pub. No.: US 2005/0186110 A1
(43) Pub. Date: Aug. 25, 2005

(54) Multilayer analysis element

(75) Inventors: Kentaro Nakamura, Asaka-shi (JP); Kazuya Kawasaki, Asaka-shi (JP); Toshihisa Ito, Asaka-shi (JP); Yoshiki Sakaino, Asaka-shi (JP); Osamu Seshimoto, Asaka-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd., Minami-ashigara-shi (JP)

(21) Appl. No.: 11/060,777

(22) Filed: Feb. 18, 2005

(30) Foreign Application Priority Data
Feb. 20, 2004 (JP) 2004-044392

(51) Int. Cl. G01N 31/22

(52) U.S. Cl. 422/56

(57) ABSTRACT

It is an object of the invention to provide a multilayer analysis element with small intra-lot and lot-to-lot differences that has high measurement accuracy and which is small in size. The present invention provides a multilayer analysis element for the analysis of a liquid sample, comprising a water impermeable planar support on one side of which at least one functional layer and at least one porous liquid sample spreading layer of non-fibrous porous film are integrally laminated in the mentioned order, wherein said spreading layer comprises a non-fibrous porous film such that, when a liquid sample containing a target substance to be measured is caused to become attached to the surface of said liquid sample spreading layer, where said liquid sample is spread and dispersed, 30% or more of said target substance to be measured can be transferred to the at least one functional layer below said liquid sample spreading layer.

### TECHNICAL FIELD

The present invention relates to a multilayer analysis element used for clinical examinations, food examinations and environmental analysis or the like.

### BACKGROUND ART

In the fields of clinical examination, food examination and environmental examination, there is a growing demand for processing a specimen quickly and easily, and analysis elements are generally employed to meet such needs. In an analysis element, the spreading layer that is used for the reception, spreading and diffusion of blood has been typically formed by a fibrous porous material, as described in JP Patent Publication (Kokai) Nos. 55-164356 A (1980), 57-66359 A (1982), and 60-222769 A (1985), for example.

The fibrous porous material has a high spreading rate upon spotting of a liquid sample and is easy to handle during manufacture. It is also compatible with viscous samples, such as whole blood, and is therefore widely used.

In the relevant fields, increasingly higher measurement accuracies (reproducibility) are being required, and several inconveniences have been identified in the fibrous porous material (fabric spreading layer). One of the inconveniencies relates to the problem of lot variations in the fabric. Normally, the fabric spreading layer is available in woven material and knitted material, and lot-to-lot and intra-lot differences in the manner of weaving or knitting have been identified. Specifically, the variations involve the number of stitches and weight per unit area, and thickness, for example. There are also lot-to-lot and intra-lot differences in the hydrophilicity of the fabric depending on the degree of washing in the material-washing step in an intermediate process. Furthermore, as the fabric spreading layer is not smooth, the spreading layer must inevitably be wedged into the lower layer if a sufficient bonding force is to be ensured by the laminating method during manufacture. As a result, the lower layer is disturbed and is not suitable for measurement requiring high accuracy. Furthermore, it is difficult for the fabric spreading layer to achieve an increase in the amount of the liquid sample that is carried to the lower layer, due to the influences of the fabric itself and the wedging in the lower layer, thereby failing to achieve higher sensitivity. When adhering the fabric to the lower layer, the fabric, by its structural nature, tends to be elongated, such that the gap volume tends to be easily varied. Consequently, the spread area easily changes upon spotting of liquid sample, thereby producing the intra-lot difference and preventing a high-accuracy measurement. In recent years, there is also a growing need for performing a measurement with smaller amounts of liquid sample. In cases involving a fabric spreading layer, as the amount of liquid sample decreases, variations in the amount of reflected light become pronounced due to the influence of the stitches, such that it becomes impossible to perform a high-accuracy measurement. Furthermore, as the amount of liquid sample is reduced, the transfer of the liquid sample to the lower layer becomes insufficient, resulting in a decrease in sensitivity.

### DISCLOSURE OF THE INVENTION

It is an object of the invention to solve the aforementioned problems of the prior art. Namely, it is an object of the invention to provide a multilayer analysis element with small intra-lot and lot-to-lot differences that has high measurement accuracy and which is small in size. It is another object of the invention to provide a multilayer analysis element with an improved detection sensitivity.

The present inventors have diligently studied to solve the aforementioned objects, and have found that that these objects can be achieved by using a non-fibrous porous film, as a liquid sample spreading layer, such that about 30% or more, preferably 60% or more of a target substance to be measured can be transferred to at least one functional layer below the liquid sample spreading layer, thereby completing the present invention.

The present invention provides a multilayer analysis element for the analysis of a liquid sample, comprising a water impermeable planar support on one side of which at least one functional layer and at least one porous liquid sample spreading layer of non-fibrous porous film are integrally laminated in the mentioned order, wherein said spreading layer comprises a non-fibrous porous film such that, when a liquid sample containing a target substance to be measured is caused to become attached to the surface of said liquid sample spreading layer, where said liquid sample is spread and dispersed, 30% or more of said target substance to be measured can be transferred to the at least one functional layer below said liquid sample spreading layer.

Preferably, the spreading layer comprises a non-fibrous porous film capable of transferring 60% or more of said target substance to be measured.

Preferably, the non-fibrous porous film comprises a porous film of an organic polymer.

Preferably, the porous film of an organic polymer is an asymmetric porous film with an asymmetry ratio of 2.0 or more, or the porous film of an organic polymer is a symmetric porous film with an asymmetry ratio of less than 2.0.

Preferably, the porous film of an organic polymer is 6, 6-nylon; 6 -nylon; acrylate copolymer; polyacrylate; polyacrylonitrile; polyacrylonitrile copolymer; polyamide, polyimide; polyamide-imide; polyurethane; polyether sulfone; polysulfone; a mixture of polyether sulfone and polysulfone; polyester; polyester carbonate; polyethylene; polyethylene chlorotrifluoroethylene copolymer; polyethylene tetrafluoroethylene copolymer; polyvinyl chloride; polyolefin; polycarbonate; polytetrafluoroethylene; polyvinylidene difluoride; polyphenylene sulfide; polyphenylene oxide; polyfluorocarbonate; polypropylene; polybenzoimidazole; polymethyl methacrylate; styrene-acrylonitrile copolymer; styrene-butadiene copolymer; a saponified product of ethylene-vinyl acetate copolymer; polyvinyl alcohol; cellulose acetate; a saponified product of cellulose acetate; cellulose acetate butyrate; a saponified product of cellulose acetate butyrate; or a mixture thereof.

Further preferably, the porous film of an organic polymer is 6, 6-nylon; 6-nylon; polyether sulfone; polysulfone; a mixture of polyether sulfone and polysulfone; polyethylene; polypropylene; polyolefin; polyacrylonitrile; polyvinyl alcohol; polycarbonate; polyester carbonate; polyphenylene oxide; polyamide, polyimide; polyamide-imide; cellulose acetate; a saponified product of cellulose acetate; or a mixture thereof.

Particularly preferably, the porous film of an organic polymer is polyethersulfone, polysulfone, cellulose acetate, a saponified product of cellulose acetate, or a mixture thereof.

### BRIED DESCRIPTION OF THE DRAWINGS

FIG. 1 shows the optical arrangement of a photometry system used in the examples. substance amount measuring device 100, specimen disposed portion 1, light source 2, light adjusting portion 3, wavelength adjusting portion 4, lenses 5a, 5b, 5c, area sensor 6 and computer 7 are shown.

FIG. 2 shows the relationship between the standard deviation (SD) of optical density and the photometry area.

### BEST MODE FOR CARRYING OUT THE INVENTION

The invention is hereafter described by way of embodiments thereof.

The multilayer analysis element of the invention for the analysis of a liquid sample comprises a water impermeable planar support on one side of which at least one functional layer and at least one porous liquid sample spreading layer of non-fibrous porous film are integrally laminated in the mentioned order. The element is characterized in that, after a liquid sample containing a target substance to be measured is caused to become attached to the surface of the spreading layer, where it is spread and diffused, the non-fibrous porous film allows about 30% or more (preferably, about 60% or more) of the target substance to be measured to be transferred to the at least one functional layer beneath the liquid sample spreading layer.

Because of the feature that the spreading layer comprises a non-fibrous porous film such that, after a liquid sample containing a target substance to be measured is caused to become attached to the surface of the spreading layer, where it is spread and diffused, the non-fibrous porous film allows about 30% or more (preferably, about 60% or more) of the target substance to be measured to be transferred to the at least one functional layer beneath the liquid sample spreading layer, higher sensitivity and higher measurement accuracy can be achieved. At the same time, the feature enables a stable manufacture of the element and reduces the lot-to-lot difference and the intra-lot difference.

In accordance with the invention, after a liquid sample containing a target substance to be measured is caused to become attached to the surface of the spreading layer, where it is spread and diffused, about 30% or more, preferably about 60% or more, and more preferably about 70% or more, of the target substance to be measured is transferred to the at least one functional layer beneath the liquid sample spreading layer.

The method of measuring the amount of the target substance to me measured that is transferred to the functional layer is not particularly limited, and a person skilled in the art can employ a suitable method, taking into account the type of the target substance to be measured, for example. In one example, an evaluation liquid containing a dye at a predetermined concentration is spotted on the multilayer analysis element and incubated thereon, and the reflection optical density is measured from the support side to determine the reflection optical density 5 minutes after the spotting. Then, the reflection optical density is similarly measured from the spreading layer side of the multilayer analysis element to determine the reflection optical density 5 minutes after the spotting. Then, the amount of the target substance to be measured that has been transferred to the functional layer can be measured in accordance with the following equation:
(Reflected optical density on the supporter side)÷(reflection optical density on the supporter side+reflection optical density on the spreading layer side)=distribution ratio.

As the water impermeable planar support, any conventional water impermeable support used in conventional analysis elements can be used. For example, it may be a film- or sheet-like transparent support made of a polymer, such as polyethylene terephthalate, bisphenol A polycarbonate, polystyrene, cellulosic ester (such as cellulose diacetate, cellulose triacetate, and cellulose acetate propionate, for example), with a thickness ranging from about 50 μm to about 1 mm, and preferably from about 80 μm to about 300 μm.

If necessary, the adhesion between the support and the functional layer provided thereon may be strengthened by providing an undercoat layer on the surface of the support. Alternatively, instead of the undercoat layer, the adhesion may be strengthened by subjecting the surface of the support to a physical or chemical activation process.

The multilayer analysis element of the invention comprises at least one porous liquid sample spreading layer of non-fibrous porous film. The porous liquid sample spreading layer is a layer having the function of spreading a component in an aqueous specimen in a planar fashion without substantially causing the component to be unevenly distributed, such that the component can be supplied to the functional layer at a substantially constant ratio per unit area.

The number of porous liquid sample spreading layers is not limited to one, and the layer may comprise a laminate of two or more layers of non-fibrous porous films adhered by an adhesive that is partially located. Physical activation treatment represented by glow discharge treatment or corona discharge treatment disclosed in Japanese Patent KOKAI 57-66359 may be conducted on at least one side of the aforementioned at least one porous liquid sample spreading layer of non-fibrous porous film. Alternatively, the porous liquid sample spreading layer may be subjected to immersing treatment with a surfactant (preferably, nonionic surfactant) disclosed in Japanese Patent KOKAI 55-164356, 57-66359, and so on, or hydrophilic treatment such as a immersing treatment with hydrophilic polymer, or a combination of two or more these treatment, and thereby the non-fibrous porous film is rendered hydrophilic. Thus, the adhesive force with the lower functional layer can be strengthened, and the spreading area can be controlled. Further, a reagent for causing a desired detection reaction, a reagent for promoting the detection reaction, a variety of reagents for reducing or preventing an interfering or blocking reaction, or some of these reagents may be contained.

The thickness, pore size, porosity, water penetration rate or the like of the porous liquid sample spreading layer of non-fibrous porous film is not particularly limited. The thickness is in the range of 50 to 500 μm, preferably 50 to 350 μm, more preferably 80 to 200 μm. The average pore size is preferably 0.001 to 100 μm, more preferably 0.1 to 50 μm. The porosity is preferably 50 to 95% more preferably 60 to 90%. The water penetration rate is preferably 1 to 5000 ml, more preferably 5 to 2000 ml per minute per cm² of non-fibrous porous film, when water is transmitted at a pressure of 1 kg/cm² at 25° C.

The porous liquid sample spreading layer of the invention comprises a non-fibrous porous film. Preferably, the non-fibrous porous film is a porous film made of an organic polymer, which may be either symmetric or asymmetric. In the case of an asymmetric porous film, the asymmetry ratio is preferably 2.0 or more. In the case of a symmetric porous film, the asymmetry ratio is preferably not more than 2.0. The asymmetric porous film herein refers to a porous film having a larger mean diameter of pores on one surface than that on the other surface. The asymmetry ratio refers to the value obtained by dividing the larger mean pore diameter with the smaller mean pore diameter.

Preferable examples of the porous film made of an organic polymer include: 6, 6-nylon; 6-nylon; acrylate copolymer; polyacrylate; polyacrylonitrile; polyacrylonitrile copolymer; polyamide, polyimide; polyamide-imide; polyurethane; polyether sulfone; polysulfone; a mixture of polyether sulfone and polysulfone; polyester; polyester carbonate; polyethylene; polyethylene chlorotrifluoroethylene copolymer; polyethylene tetrafluoroethylene copolymer; polyvinyl chloride; polyolefin; polycarbonate; polytetrafluoroethylene; polyvinylidene difluoride; polyphenylene sulfide; polyphenylene oxide; polyfluorocarbonate; polypropylene; polybenzoimidazole; polymethyl methacrylate; styrene-acrylonitrile copolymer; styrene-butadiene copolymer; a saponified product of ethylene-vinyl acetate copolymer; polyvinyl alcohol; cellulose acetate; a saponified product of cellulose acetate; cellulose acetate butyrate; a saponified product of cellulose acetate butyrate; and a mixture thereof. Of these, more preferable are: 6, 6-nylon; 6-nylon; polyether sulfone; polysulfone; a mixture of polyether sulfone and polysulfone; polyethylene; polypropylene; polyolefin; polyacrylonitrile; polyvinyl alcohol; polycarbonate; polyester carbonate; polyphenylene oxide; polyamide; polyimide; polyamide-imide; cellulose acetate; a saponified product of cellulose acetate; and a mixture thereof. Particularly, polyethersulfone, polysulfone, cellulose acetate, a saponified product of cellulose acetate, and a mixture thereof are preferable.

The non-fibrous porous film containing a reagent, which refers to a film containing a reagent, may be prepared by immersing a porous film in a solution of reagent and then drying it. In another method, the reagent-containing non-fibrous porous film may be prepared by applying a reagent solution to a porous film and then drying it. The means of preparing the film is not particularly limited.

The multilayer analysis element of the invention comprises at least one functional layer. The functional layer may consist of one or more layers.

Examples of the functional layer include: an adhesion layer for adhering a spreading layer and a functional layer; a water-absorbing layer for absorbing a liquid reagent; a mordant layer for preventing the diffusion of a dye produced by chemical reaction; a gas transmitting layer for selectively transmitting gas; an intermediate layer for suppressing or promoting the transport of substance between layers; an elimination layer for eliminating an endogenous substance; a light-shielding layer for enabling a stable measurement of reflected light; a color shielding layer for suppressing the influence of an endogenous dye; a separation layer for separating blood cells and plasma; a reagent layer containing a reagent that reacts with a target of analysis; and a coloring layer containing a coloring agent.

In an example of the invention, a hydrophilic polymer layer may be provided on the support as a functional layer via another layer as needed, such as an underlayer. The hydrophilic polymer layer may include: a non-porous, water-absorbing and water-permeable layer basically consisting only of a hydrophilic polymer; a reagent layer comprising a hydrophilic polymer as a binder and some or all of a coloring agent that is directly involved in a coloring reaction; and a detection layer containing a component (such as a dye mordant) that immobilizes the coloring agent in the hydrophilic polymer.

(Reagent Layer)

The reagent layer is a water-absorbing and water-permeable layer which contains a hydrophilic polymer binder in which at least some of a reagent composition that reacts with a detected component in an aqueous liquid to produce an optically detectable change is substantially uniformly dispersed. The reagent layer includes an indicator layer and a coloring layer.

A hydrophilic polymer that can be used as the binder in the reagent layer is generally a natural or synthetic hydrophilic polymer with a swelling rate ranging from about 150% to about 2000%, and preferably from about 250% to about 1500% at 30° C., upon water absorption. Examples of such a hydrophilic polymer include: a gelatin (such as acid-treated gelatin or deionized gelatin, for example) disclosed in JP Patent Publication (Kokai) No. 60-108753 A (1985); a gelatin derivative (such as phthalated gelatin or hydroxyacrylate graft gelatin, for example); agarose; pullulan; pullulan derivative; polyacrylamide; polyvinyl alcohol; and polyvinylpyrrolidone.

The reagent layer may be a layer appropriately cross-linked and cured using a crosslinking agent. Examples of the crosslinking agent include: for gelatin, known vinylsulfon crosslinking agent such as 1, 2-bis(vinylsulfonyl acetoamide)ethane and bis(vinylsulfonylmethyl)ether and aldehydes; and, for methallyl alcohol copolymer, aldehydes and epoxy compounds containing two glycidyl groups and the like.

The thickness of the reagent layer when dried is preferably in the range of about 1 μm to about 100 μm, and more preferably about 3 μm to about 30 μm. Preferably, the reagent layer is substantially transparent.

The reagent contained in the reagent layer or other layers in the multilayer analysis element of the invention may be appropriately selected depending on the tested substance.

For example, when analyzing ammonia (in cases where the tested substance is ammonia or ammonia producing substance), examples of a color ammonia indicator include: leuco dyes, such as leucocyanine dye, nitro-substituted leuco dye, and leucophthalein dye (see U.S. Pat. No. Re. 30267 or JP Patent Publication (Kokoku) No. 58-19062 B (1983); pH indicators, such as bromophenol blue, bromocresol green, bromthymol blue, quinoline blue, and rosolic acid (see Encyclopaedia Chimica, Vol. 10, pp 63-65, published by Kyoritsu Shuppan K. K.); triarylmethane dye precursors; leucobenzylidene dyes (see JP Patent Publication (Kokai) Nos. 55-379 A (1980) and 56-145273 A (1981)); diazonium salt and azo dye couplers; and base bleaching dyes. The content of the color ammonia indicator with respect to the weight of the binder is preferably in the range of about 1 to about 20% by weight.

The reagent that reacts with an ammonia producing substance as a tested substance to produce ammonia is preferably an enzyme or a reagent that contains an enzyme, and the enzyme suitable for analysis may be selected appropriately depending on the type of the ammonia producing substance as the tested substance. When an enzyme is used as the regent, the combination of the ammonia producing substance and the reagent is determined by the specificity of the enzyme. Examples of the combination of the ammonia producing substance and the enzyme as the reagent include: urea/urease; creatinine/creatinine deiminase; amino acid/amino-acid dehydrogenase; amino acid/amino-acid oxidase; amino acid/ammonia lyase; amine/amine oxidase; diamine/amine oxidase; glucose and phosphoamidate/phosphoamidate-hexose phosphotransferase; ADP/carbamate kinase and carbamoyl phosphate; acid amide/amide hydrolase; nucleobase/nucleobase deaminase; nucleoside/nucleoside deaminase; nucleotide/nucleotide deaminase; guanine/guanase. An alkaline buffer that can be used in the reagent layer during the analysis of ammonia may be a buffer with a pH of 7.0 to 12.0, and preferably 7.5 to 11.5.

In addition to the reagent that reacts with an ammonia producing substance to produce ammonia, an alkaline buffer, and a hydrophilic polymer binder with a film-forming capability, the reagent layer for the analysis of ammonia may contain a wetting agent, a binder crosslinking agent (curing agent), a stabilizing agent, a heavy-metal ion trapping agent (complexing agent) or the like, as needed. The heavy-metal ion trapping agent is used for masking heavy-metal ions that inhibit enzyme activity. Examples of the heavy-metal ion trapping agent include complexanes such as: EDTA.2Na; EDTA.4Na; nitrilotriacetic acid (NTA); and diethylenetriaminepentaacetic acid.

Examples of the glucoses-measuring reagent composition include glucose oxidase, peroxidase, 4-aminoantipyrine or derivatives thereof, and an improved Trinder's reagent composition including 1,7-dihydroxynaphthalene, as described in U.S. Pat. No. 3,992,158, JP Patent Publication (Kokai) Nos. 54-26793 A (1979), 59-20853 A (1984), 59-46854 A (1984), and 59-54962 A (1984).

(Light-Shielding Layer)

A light-shielding layer may be provided on top of the reagent layer as needed. The light-shielding layer is a water-transmitting or water-permeable layer comprising a small amount of hydrophilic polymer binder with a film-forming capability in which particles with light-absorbing or light-reflecting property (together referred to as “light-shielding property”) are dispersed. The light-shielding layer blocks the color of the aqueous liquid supplied to the spreading layer (to be described later) by spotting, particularly the color red of hemoglobin in the case where the sample is whole blood, when measuring detectable changes (in color or in coloration, for example) that developed in the reagent layer by reflection photometry from the light-transmitting support side. In addition, the light-shielding layer also functions as a light-reflecting layer or a background layer.

Examples of the particle with light-reflecting property include: titanium dioxide particles (microcrystalline particles of rutile type, anatase type, or brookite type, with a particle diameter of about 0.1 μm to about 1.2 μm); barium sulfate particles; aluminum particles; and microflakes. Examples of the light-absorbing particles include: carbon black, gas black, and carbon microbeads, of which titanium dioxide particles and barium sulfate particles are preferable. Particularly, anatase-type titanium dioxide particles are preferable.

Examples of the hydrophilic polymer binder with a film-forming ability include hydrophilic polymers similar to the hydrophilic polymer used for the manufacture of the aforementioned reagent layer, as well as regenerated cellulose of weak hydrophilicity and cellulose acetate. Of these, gelatin, gelatin derivatives, and polyacrylamide are preferable. Gelatin or gelatin derivatives may be used in a mixture with a known curing agent (crosslinking agent).

The light-shielding layer may be provided by applying an aqueous dispersion of light-shielding particles and a hydrophilic polymer onto the reagent layer by a known method and then drying. Alternatively, instead of providing the light-shielding layer, a light-shielding particle may be contained in the aforementioned spreading layer.

(Adhesive Layer)

An adhesive layer may be provided on top of the reagent layer in order to adhere and stack the spreading layer, via a layer such as a light-shielding layer as needed.

The adhesive layer is preferably made of a hydrophilic polymer such that the adhesive layer is capable of adhering the spreading layer when moistened or swollen with water, so that the individual layers can be integrated. Examples of the hydrophilic polymer that can be used for the manufacture of the adhesive layer are hydrophilic polymers similar to those hydrophilic polymers used for the manufacture of the reagent layer. Of these, gelatin, gelatin derivatives, and polyacrylamide are preferable. The dried-film thickness of the adhesive layer is generally about 0.5 μm to about 20 μm, preferably about 1 μm to about 10 μm.

The adhesive layer may be provided on any other desired layer (in addition to the reagent layer) for improving the adhesion between other layers. The adhesive layer may be provided by applying an aqueous solution of a hydrophilic polymer and, as needed, a surface active agent or the like onto the support or the reagent layer by a known method, for example.

(Water-Absorbing Layer)

The multilayer analysis element of the invention may be provided with a water-absorbing layer between the support and the reagent layer. The water-absorbing layer is a layer comprised mainly of a hydrophilic polymer that becomes swollen by absorbing water, and it can absorb water in the aqueous liquid sample that has reached or permeated the boundary of the water-absorbing layer. The water-absorbing layer functions to promote the permeation of blood plasma, which is the aqueous liquid component in the case where the sample is whole blood, to the reagent layer. The hydrophilic polymer used in the water-absorbing layer may be selected from those used in the aforementioned reagent layer. For the water-absorbing layer, gelatin, gelatin derivatives, polyacrylamide, and polyvinyl alcohol are generally preferable. Particularly, the aforementioned gelatin and deionized gelatin are preferable. Most particularly, the aforementioned gelatin used in the reagent layer is preferable. The thickness of the water-absorbing layer when dried is about 3 μm to about 100 μm, preferably about 5 μm to about 30 μm. The amount of coating is about 3 g/m² to about 100 g/m², and preferably about 5 g/m² to about 30 g/m². The pH of the water-absorbing layer upon use (during the implementation of analysis operation) may be adjusted by adding a pH buffer or a known basic polymer or the like in the water-absorbing layer, as will be described later. The water-absorbing layer may further contain a known dye mordant or a polymer dye mordant, for example.

(Detection Layer)

The detection layer is generally a layer in which a dye or the like produced in the presence of a detected component is diffused and optically detectable through a support, and it may comprise a hydrophilic polymer. The detection layer may contain a dye mordant, such as a cationic polymer for an anionic dye, for example. The water-absorbing layer generally refers to a layer in which the dye produced in the presence of the detected component is not substantially diffused, and it is distinguished from the detection layer in this respect.

The reagent layer, water-absorbing layer, adhesive layer, and spreading layer or the like may each contain a surfactant, of which one example is a nonionic surfactant. Examples of nonionic surfactant include: p-octylphenoxypolyethoxyethanol, p-nonylphenoxypolyethoxyethanol, polyoxyethylene oleyl ether, polyoxyethylene sorbitan monolaurate, p-nonylphenoxypolyglycidol, and octyl glucoside. By adding the nonionic surfactant in the spreading layer, its function of spreading the aqueous liquid sample (metering function) can be improved. By adding the nonionic surfactant in the reagent layer or the water-absorbing layer, the water in the aqueous liquid sample can be facilitated to be substantially uniformly absorbed by the reagent layer or the water-absorbing layer during analysis operation, so that the contact of the liquid with the spreading layer can take place quickly and substantially uniformly.

In order to laminate a porous liquid sample spreading layer of non-fibrous porous film onto a functional layer such as a reagent layer, a water-absorbing layer or an adhesive layer, a method disclosed in JP Patent Publication (Kokai) Nos. 55-164356 A (1980), and 57-66359 A (1982) and the like. Namely, after a functional layer such as a reagent layer, a water-absorbing layer or an adhesive layer is coated and before such layer is dried, or after the functional layer is dried, an aqueous solution containing water and a surfactant, an aqueous solution containing a surfactant and a hydrophilic polymer, an organic solvent, or an aqueous solution containing an organic solvent or the like is provided substantially uniformly using wire bar coating machine, a coating machine with die or the like, and thus the functional layer is swelled or dissolved. Then, a porous liquid sample spreading layer of non-fibrous porous film is substantially uniformly laminated onto the swelled or dissolved functional layer while a weak pressure is applied so as to be integrated therewith. When the functional layer is swelled or dissolved, it may be warmed by radiation heat of infra-red radiation heater, or may be warmed by contacting the support with a heater.

The tested substance that can be analyzed by the multilayer analysis element of the invention is not particularly limited, and a particular component in an any liquid sample (including bodily fluids, such as whole blood, blood plasma, blood serum, lymph fluid, urine, saliva, cerebrospinal fluid, and vaginal fluid; drinking water, liquors, river water, and factory waste water) can be analyzed. For example, the multilayer analysis element can be used for the analysis of albumin (ALB), glucose, urea, bilirubin, cholesterol, proteins, enzymes (including blood enzymes such as LDH (lactate dehydrogenase), CPK (creatine kinase), ALT (alanine aminotransferase), AST (aspartate aminotransferase), and γ GT (γ-glutamyltranspeptidase).

The multilayer analysis element of the invention can be prepared by known methods. Hemolysis reagent may be added in a reagent solution in advance for coating or impregnation. In another method, an aqueous solution, an organic solvent (ethanol or methanol, for example), or a solution of a water-organic solvent mixture of the hemolysis reagent, either alone or in combination with a surface active agent or a hydrophilic polymer for spread area control, may be applied onto the spreading layer for impregnation. The tested substance may be analyzed using this in accordance with a known method.

For example, the multilayer analysis element of the invention may be cut into small pieces of squares with each side measuring about 5 mm to about 30 mm, or circles of similar sizes. They can then be accommodated in a slide frame such as those described in JP Patent Publication (Kokoku) No. 57-283331 B (1982) (corresponding to U.S. Pat. No. 4,169,751), JP Utility Model Publication (Kokai) No. 56-142454 U (1981) (corresponding to U.S. Pat. No. 4,387,990), JP Patent Publication (Kokai) No. 57-63452 A (1982), JP Utility Model Publication (Kokai) No. 58-32350 U (1983), and JP Patent Publication (Kohyo) No. 58-501144 A (1983) (corresponding to W0083/00391), and the slide can then be used as a chemical analysis slide. This is preferable from the viewpoint of manufacture, packaging, shipping, storage, measurement operation, and so on. Depending on the purpose of use, the element may be stored in a cassette or a magazine in the form of an elongated tape. Alternatively, small pieces may be stored in a container with an opening, they may be affixed to or accommodated in an opening card, or the cut pieces may be used as is.

In the multilayer analysis element of the invention, about 2 μL to about 30 μL, and preferably 4 μL to 15 μL of an aqueous liquid sample is spotted on the porous liquid sample spreading layer. The thus spotted multilayer analysis element is then incubated at a certain temperature ranging from about 20° C. to about 45° C., preferably from about 30° C. to about 40° C., for 1 to 10 minutes. The coloration or change in color in the multilayer analysis element is measured from the support side by reflection photometry, and the amount of the tested substance in the specimen can be determined using a prepared analytical curve based on the principle of colorimetry.

A highly accurate quantitative analysis can be performed by a very simple procedure using a chemical analyzer such as those disclosed in JP Patent Publication (Kokai) Nos. 60-125543 A (1985), 60-220862 A (1985), 61-294367 A (1986), 58-161867 A (1983) (corresponding to U.S. Pat. No. 4,424,191), for example. Depending on the purpose or the desired level of accuracy, the degree of coloration may be judged visually and a semi-quantitative analysis may be performed.

Since the multilayer analysis element of the invention is stored in a dry state until the beginning of analysis, there is no need to prepare a reagent as required. Further, as the reagents are generally more stable in a dry state, the multilayer analysis element of the invention can be more simply and quickly utilized than the so-called wet methods, in which solutions of reagents must be prepared as required. The invention is also superior as an examination method whereby a highly accurate examination can be performed with small quantities of liquid sample.

The invention will be hereafter described in more detail by way of examples thereof. The invention is not limited by these examples.

### EXAMPLES

### Example 1

### Comparison of the Distribution Ratios of a Non-Adsorptive Dye (Tartrazine) in a Non-Adsorptive Dye-Containing Solution in Different Spreading layer materials

(1) Method of Preparing a Multilayer Analysis Element for the Measurement of the Non-Adsorptive Dye Distribution Ratios in the Case where a Polysulfone Film is used as the Spreading Layer

An aqueous solution (pH=5.1) with the following composition was coated to a clear and colorless smooth film of polyethylene terephthalate with a thickness of 180 μm and having a gelatin undercoat, in the following amounts of coating, and then dried to obtain a water-absorbing layer.

| | | |
|---|---|---|
| Gelatin | 16.6 | g/m² |
| Polyoxy(2-hydroxy)propylene nonylphenyl ether | 0.2 | g/m² |

Then, water was supplied to the entire surface of the water-absorbing layer with a supply volume of about 15 g/m², thereby wetting the same. A polysulfone film (SE-200: manufactured by Fuji Photo Film Co., Ltd.; to be hereafter referred to as a PS film) was then laminated under a slight pressure, dried, and adhered. Thus a multilayer analysis element for the measurement of the non-adsorptive dye distribution ratios in which a polysulfone film was used as the spreading layer, was prepared.

The multilayer analysis element was cut into rectangular chips measuring 12 mm×13 mm and accommodated in a slide frame (see JP Patent Publication (Kokai) No. 57-63452 A (1982)), thereby preparing a slide 1 for the measurement of the non-adsorptive dye distribution ratios.

(2) Method of Preparing a Multilayer Analysis Element for the Measurement of the Non-Adsorptive Dye Distribution Ratios in the Case where a Polyethersulfone Film is used as the Spreading Layer

Up to the preparation of the water-absorbing layer, the same procedure as that (1) for the preparation of the multilayer analysis element for the measurement of the non-adsorptive dye distribution ratios in the case where a polysulfone film was used as the spreading layer was used. Then, after wetting the water-absorbing layer by supplying water to the entire surface thereof at the supply volume of about 15 g/m², a polyethersulfone film (“Precision”, manufactured by Pall Corporation; to be hereafter referred to as a PES film) was laminated under a slight pressure, dried and then adhered.

Thus a multilayer analysis element for the measurement of the non-adsorptive dye distribution ratios in the case where a polyethersulfone film was used as the spreading layer, was prepared.

This multilayer analysis element was cut into rectangular chips measuring 12 mm×13 mm, and these were accommodated in a slide frame (see JP Patent Publication (Kokai) No. 57-63452 A (1982)), thereby preparing a slide 2 for the measurement of the non-adsorptive dye distribution ratios.

(3) Method of Preparing a Multilayer Analysis Element for the Measurement of the Non-Adsorptive Dye Distribution Ratios in the Case where a Cellulose Acetate Film is used as the Spreading Layer

Up to the preparation of the water-absorbing layer, the same procedure as that (1) for the preparation of the multilayer analysis element for the measurement of the non-adsorptive dye distribution ratios in the case where a polysulfone film was used as the spreading layer was used. Then, after wetting the water-absorbing layer by supplying water to the entire surface thereof at the supply volume of about 15 g/m², a cellulose acetate film (FM-500, manufactured by Fuji Photo Film Co., Ltd.; to be hereafter referred to as a FM film) was laminated under a slight pressure, dried and then adhered.

This multilayer analysis element was cut into rectangular chips measuring 12 mm×13 mm, and these were accommodated in a slide frame (see JP Patent Publication (Kokai) No. 57-63452 A (1982)), thereby preparing a slide 3 for the measurement of the non-adsorptive dye distribution ratios.

(4) Method of Preparing a Multilayer Analysis Element for the Measurement of the Non-Adsorptive Dye Distribution Ratios in the Case where a Knitted Fabric is used as the Spreading Layer

Up to the preparation of the water-absorbing layer, the procedure was the same as that (1) for the preparation of the multilayer analysis element for the measurement of the non-adsorptive dye distribution ratios in the case where a polysulfone film was used as the spreading layer. Then, after wetting the reagent layer by supplying water to the entire surface thereof at the supply volume of about 30 g/m², a tricot-knitted fabric (to be hereinafter referred to as a knitted fabric) knitted at the 36 gauge with a yarn of polyethylene terephthalate corresponding to 50 denier was laminated under a slight pressure, dried and then adhered. Thus a multilayer analysis element for the measurement of the non-adsorptive dye distribution ratios in the case where a knitted fabric was used as the spreading layer was prepared.

The multilayer analysis element was cut into rectangular chips measuring 12 mm×13 mm and the chips were accommodated in a slide frame (see JP Patent Publication (Kokai) No. 57-63452 A (1982)), thereby preparing a slide 4 for the measurement of the non-adsorptive dye distribution ratios.

(5) Method of Preparing a Multilayer Analysis Element for the Measurement of the Non-Adsorptive Dye Distribution Ratios in the Case where a Woven Fabric is used as the Spreading Layer

Up to the preparation of the water-absorbing layer, the procedure was the same as that (1) for the preparation of the multilayer analysis element for the measurement of the non-adsorptive dye distribution ratios in the case where a polysulfone film was used as the spreading layer. Then, after wetting the reagent layer by supplying water to the entire surface thereof at the supply volume of about 30 g/m², a woven fabric (to be hereinafter referred to as a woven fabric) prepared by subjecting one side of a broadcloth woven with a cotton blended yarn of No. 80 (KSR808000 manufactured by Kuraray Co., Ltd.; 65% Tetron (polyethylene terephthalate from Toray Industries, Inc.) and 35% cotton) to a glow discharge process (50 Hz, 600V and 0.5A; pressure adjusted appropriately) for 60 seconds was laminated under a slight pressure, dried and then adhered. Thus a multilayer analysis element for the measurement of the non-adsorptive dye distribution ratios in which a knitted fabric was used as the spreading layer was prepared.

The multilayer analysis element was cut into rectangular chips measuring 12 mm×13 mm and the chips were accommodated in a slide frame (see JP Patent Publication (Kokai) No. 57-63452 A (1982)), thereby preparing a slide 5 for the measurement of the non-adsorptive dye distribution ratios.

(6) Distribution Ratios of a Non-Adsorptive Dye (Tartrazine) in a Non-Adsorptive Dye-Containing Solution in Different Spreading Layer Materials

Tartrazine (manufactured by Aldrich Chemical Co., Inc.) was dissolved in a 7% HSA solution to the ratios of 0%, 0.05%, and 0.10% (by weight), thereby preparing evaluation liquids. 10 μL each of the evaluation liquids was spotted on slides 1 to 5 for the measurement of the non-adsorptive dye distribution ratios. Thereafter, each slide was incubated at 37° C., and the reflective optical density was measured at 400 nm from the support side in order to determine the reflective optical density 5 minutes after spotting. Similarly, the reflection optical density of each slide was measured at 400 nm from the spreading layer side in order to determine the reflection optical density 5 minutes after spotting.

TABLE 1
Distribution ratios of a non-adsorptive dye (tartrazine
dye) in a non-adsorptive dye-containing solution
in different spreading layer materials

| Density of | | | | | |
|---|---|---|---|---|---|
| non-adsorptive | | | | | |
| dye liquid | Slide 1 | Slide 2 | Slide 3 | Slide 4 | Slide 5 |
| 0.05% | 73% | 72% | 83% | 57% | 19% |
| 0.10% | 74% | 79% | 85% | 61% | 28% |

*Distribution ratio = Reflective optical density on the support side (tartrazine X % − tartrazine 0%) ÷ (reflective optical density on the support side (tartrazine X % − tartrazine 0%) + reflective optical density on the spreading layer side (tartrazine X % − tartrazine 0%))

As shown, slide 5 utilizing a woven fabric is capable of transferring only about 30% or less of the non-adsorptive dye to a lower layer of the spreading layer. Slide 4 utilizing a knitted fabric is only capable of about 60% or less. On the other hand, it was found that slides 1, 2 and 3, in which non-fibrous porous films, namely, a polysulfone film, a polyether sulfone film or a cellulose acetate membrane, are used in the spreading layer, are capable of transferring about 60% or more of the non-adsorptive dye to the lower layer of the spreading layer.

### Example 2

### Results Concerning the Sensitivity and Accuracy of the Multilayer Analysis Element for the Analysis of Ca, ALB and ALT using Different Materials for the Spreading Layer

(1) Method of Preparing a Multilayer Analysis Element for the Analysis of Ca using a Polysulfone Film as the Spreading Layer

An aqueous solution (pH=5.6) with the following composition was coated to a clear and colorless smooth film of polyethylene terephthalate with a thickness of 180 μm and having a gelatin undercoat, in the following amounts of coating, and then dried to obtain a water-absorbing layer.

| | | |
|---|---|---|
| Gelatin | 11.7 | g/m² |
| 1N potassium hydroxide | 1.2 | g/m² |
| Titanium oxide | 0.8 | g/m² |
| Polyoxy(2-hydroxy)propylene nonylphenyl ether | 0.3 | g/m² |

Then, an aqueous solution (pH=5.3) of the following composition was coated to the water-absorbing layer in the following amounts of coating, and then dried, thereby obtaining a reagent layer.

| | | |
|---|---|---|
| Gelatin | 11.9 | g/m² |
| 2-morpholinoethanesulfonic acid, monohydrate | 6.4 | g/m² |
| 1N potassium hydroxide | 7.0 | g/m² |
| CPA(III) | 0.4 | g/m² |
| Polyoxy(2-hydroxy)propylene nonylphenyl ether | 0.4 | g/m² |
| Diisooctyl sodium sulfosuccinate | 0.1 | g/m² |

Water was supplied to the entire surface of the reagent layer at the supply volume of about 15 g/m² to wet the reagent layer, and then a polysulfone film (SE-200: manufactured by Fuji Photo Film Co., Ltd.; to be hereafter referred to as a PS film) was laminated under a slight pressure, dried, and adhered. Thus a multilayer analysis element for the analysis of Ca in which a polysulfone film was used as the spreading layer was prepared.

The multilayer analysis element was cut into rectangular chips measuring 12 mm×13 mm and accommodated in a slide frame (see JP Patent Publication (Kokai) No. 57-63452 A (1982)), thereby preparing a slide 1 for the analysis of Ca.

(2) Method of Preparing a Multilayer Analysis Element for the Analysis of Ca in which a Knitted Fabric is Used as the Spreading Layer

Up to the preparation of the reagent layer, the procedure was the same as that (1) for the preparation of the multilayer analysis element for the analysis of Ca in the case where a polysulfone film was used as the spreading layer. Then, after wetting the reagent layer by supplying water to the entire surface thereof at the supply volume of about 30 g/m², a tricot-knitted fabric (to be hereinafter referred to as a knitted fabric) knitted at the 36 gauge with a yarn of polyethylene terephthalate corresponding to 50 denier was laminated under a slight pressure, dried and then adhered.

An ethanol solution with the following composition was then coated to the fabric in the following amounts of coating, and then dried, thereby preparing a multilayer analysis element for the analysis of Ca in which a knitted fabric was used as the spreading layer.

| | |
|---|---|
| Polyvinylpyrrolidone | 3.3 g/m² |
| Polyoxyethylene (10) octylphenylether | 0.4 g/m² |

The multilayer analysis element was cut into rectangular chips measuring 12 mm×13 mm and the chips were accommodated in a slide frame (see JP Patent Publication (Kokai) No. 57-63452 A (1982)), thereby preparing a slide 2 for the analysis of Ca.

(3) Comparison of Sensitivity and Measurement Accuracy

10 μL each of water and a control serum with a Ca concentration of 15.2 mg/dL was spotted on the aforementioned slides 1 and 2 for the analysis of Ca. Each slide was then incubated at 37° C., and the reflective optical density was measured at 625 nm from the support side in order to determine the reflective optical density 4 minutes after the spotting, and the sensitivity (the difference in reflective optical density between when the control serum of 15.2 mg/dL was spotted and when water was spotted (dODr (15.2 mg/dL-0 mg/dL))) was compared. Further, the accuracy (CV (%)) was compared when the 10 μL of the control serum was spotted with the Ca concentrations of 6.1, 9.7, and 15.2 mg/dL. Table 2 shows the results of comparison of sensitivity, and Table 3 shows the results of comparison of accuracy.

TABLE 2
Result of sensitivity comparison

| | Sensitivity(dODr | Sensitivity |
|---|---|---|
| | (15.2 mg/dL-0 mg/dL)) | ratio |
| Slide 1 for Ca analysis | 0.350 | 1.13 |
| Slide 2 for Ca analysis | 0.310 | 1 |

TABLE 3
Result of accuracy (CV (%)) comparison

| Ca concentration | Slide 1 for | Slide 2 for |
|---|---|---|
| (mg/dL) | Ca analysis | Ca analysis |
| 6.1 | 1.2% | 1.5% |
| 9.7 | 0.7% | 0.9% |
| 15.2 | 0.7% | 1.0% |

The multilayer analysis element 1 for Ca analysis in which a PS film is used as the spreading layer has better sensitivity than the multilayer analysis element 2 for Ca analysis in which a knitted fabric is used as the spreading layer. It also has improved measurement accuracy.

(4) Method of Preparing the Multilayer Analysis Element for ALB Analysis in which a Polysulfone Film is Used as the Spreading Layer

An aqueous solution (pH=2.8) with the following composition was coated to a clear and colorless smooth film of polyethylene terephthalate with a thickness of 180 μm and having a gelatin undercoat, in the following amounts of coating, and then dried to obtain a reagent layer.

| | | |
|---|---|---|
| Acrylamide-N-vinylpyrrolidone-methacryl | 49.6 | g/m² |
| alcohol copolymer | | |
| DL-malic acid | 4.8 | g/m² |
| Bromocresol green | 0.7 | g/m² |
| Glycerin | 4.8 | g/m² |
| Polyoxy(2-hydroxy)propylene nonylphenyl ether | 1.5 | g/m² |

A water-ethanol mixture (1:1) was supplied to the entire surface of the reagent layer at the supply volume of about 15 g/m² to wet the reagent layer, and then a polysulfone film (SE-200: manufactured by Fuji Photo Film Co., Ltd.; to be hereafter referred to as a PS film) was laminated under a slight pressure, dried, and adhered.

Thus a multilayer analysis element for the analysis of ALB in which a polysulfone film was used as the spreading layer was prepared.

The multilayer analysis element was cut into rectangular chips measuring 12 mm×13 mm and accommodated in a slide frame (see JP Patent Publication (Kokai) No. 57-63452 A (1982)), thereby preparing a slide 1 for the analysis of ALB.

(5) Method of Preparing a Multilayer Analysis Element for the Analysis of ALB in which a Knitted Fabric is Used as the Spreading Layer

Up to the preparation of the reagent layer, the procedure was the same as that (4) for the preparation of the multilayer analysis element for the analysis of ALB in which a polysulfone film was used as the spreading layer. Then, after wetting the reagent layer by supplying a water-ethanol mixture (1:1) to the entire surface of the reagent layer at the supply volume of about 30 g/m², a tricot-knitted fabric (to be hereinafter referred to as a knitted fabric) knitted at the 36 gauge with a yarn of polyethylene terephthalate corresponding to 50 denier was laminated under a slight pressure, dried and then adhered.

An ethanol solution with the following composition was then coated to the fabric in the following amounts of coating, and then dried, thereby preparing a multilayer analysis element for the analysis of ALB in which a knitted fabric was used as the spreading layer.

| | |
|---|---|
| Polyvinylpyrrolidone | 6.6 g/m² |
| DL-fumaric acid | 6.6 g/m² |
| Polyoxyethylene (7) oleylether | 3.3 g/m² |

The multilayer analysis element was cut into rectangular chips measuring 12 mm×13 mm and the chips were accommodated in a slide frame (see JP Patent Publication (Kokai) No. 57-63452 A (1982)), thereby preparing a slide 2 for the analysis of ALB.

(6) Comparison of Sensitivity and Measurement Accuracy

10 μL each of water and a control serum with an ALB concentration of 6.0 g/dL was spotted on the aforementioned slides 1 and 2 for ALB analysis. Each slide was then incubated at 37° C., and the reflective optical density was measured at 625 nm from the support side. The reflective optical density 4 minutes after the spotting was then determined, and the sensitivity (the difference between the reflective optical density when the control serum of 6.0 g/dL was spotted and that when water was spotted (dODr (6.0 g/dL-0 g/dL))) was compared. Further, the accuracy (standard deviation <SD>g/dL) was compared when the 10 μL of the control serum was spotted with the ALB concentrations of 1.7, 3.9, and 6.0 g/dL. Table 4 shows the results of comparison of sensitivity, and Table 5 shows the results of comparison of accuracy.

TABLE 4
Result of sensitivity comparison

| | Sensitivity(dODr | Sensitivity |
|---|---|---|
| | (6.0 g/dL-0 g/dL)) | ratio |
| Slide 1 for ALB analysis | 0.766 | 1.08 |
| Slide 2 for ALB analysis | 0.707 | 1 |

TABLE 5
Result of accuracy (standard deviation <SD>g/dL) comparison

| ALB concentration | Slide 1 for | Slide 2 for |
|---|---|---|
| (g/dL) | ALB analysis | ALB analysis |
| 1.7 | 0.04 | 0.03 |
| 3.9 | 0.04 | 0.08 |
| 6.0 | 0.01 | 0.10 |

The multilayer analysis element 1 for ALB analysis in which a PS film is used as the spreading layer has better sensitivity than the multilayer analysis element 2 for ALB analysis in which a knitted fabric is used as the spreading layer. The multilayer analysis element 1 also has an improved measurement accuracy.

(7) Method of Preparing the Multilayer Analysis Element for ALT Analysis in which a Polysulfone Film is Used as the Spreading Layer

An aqueous solution (pH=6.5) with the following composition was coated to a clear and colorless smooth film of polyethylene terephthalate with a thickness of 180 μm and having a gelatin undercoat, in the following amounts of coating, and then dried to obtain a reagent layer.

| | | |
|---|---|---|
| Gelatin | 18.5 | g/m² |
| Polyoxy(2-hydroxy)propylene nonylphenyl ether | 0.7 | g/m² |
| Peroxidase | 14.8 | KU/m² |
| Flavin adenine dinucleotide disodiumu | 0.02 | g/m² |
| Cocarboxylase | 0.09 | g/m² |
| 2-(4-hydroxy-3,5-dimethoxyphenyl)-4-[4- | 0.28 | g/m² |
| [dimethyamino)phenyl]-5-phenethylimidazole | | |
| (leuco dye) acetate | | |
| pyruvate oxidase | 3.4 | KU/m² |
| bis[(vinylsulfonylmethylcarbonyl)amino]methane | 0.6 | g/m² |

A water was supplied to the entire surface of the reagent layer at the supply volume of about 15 g/m² to wet the reagent layer, and then a polysulfone film (SE-200: manufactured by Fuji Photo Film Co., Ltd.; to be hereafter referred to as a PS film) was laminated under a slight pressure, dried, and adhered.

An aqueous solution (pH7.5) with the following composition was then coated onto the polysulfone film in the following amounts of coating, and then dried, thereby preparing a multilayer analysis element for the analysis of ALT in which a polysulfone film was used as the spreading layer.

| | | |
|---|---|---|
| Polyethyleneglycol (10) octylphenylether | 0.2 | g/m² |
| Polyethyleneglycol (40) octylphenylether | 1.32 | g/m² |
| Cellulose ether (Metolose 90SH100) | 0.83 | g/m² |
| Tris(hydroxymethyl)aminomethane | 0.36 | g/m² |
| Potassium phosphate | 0.43 | g/m² |
| Disodium α-keto glutarate dihydrate | 0.38 | g/m² |
| L-alanine | 2.6 | g/m² |
| Magnesium chloride hexahydrate | 0.23 | g/m² |
| Ascorbate oxidase | 4.5 | KU/m² |

The multilayer analysis element was cut into rectangular chips measuring 12 mm×13 mm and accommodated in a slide frame (see JP Patent Publication (Kokai) No. 57-63452 A (1982)), thereby preparing a slide 1 for the analysis of ALT.

(8) Method of Preparing a Multilayer Analysis Element for the Analysis of ALT in which a Cellulose Acetate Film is Used as the Spreading Layer

Up to the preparation of the reagent layer, the procedure was the same as that (7) for the preparation of the multilayer analysis element for the analysis of ALT in which a polysulfone film was used as the spreading layer. Then, after wetting the reagent layer by supplying a water to the entire surface of the reagent layer at the supply volume of about 15 g/m², a cellulose acetate film (FM-500, manufactured by Fuji Photo Film Co., Ltd.; to be hereafter referred to as a FM film) was laminated under a slight pressure, dried and then adhered.

Further, an aqueous solution which is the same as that (7) for the preparation of the multilayer analysis element for the analysis of ALT in which a polysulfone film was used as the spreading layer, was coated on the FM film, and dried thereby preparing a multilayer analysis element for the analysis of ALT in which a cellulose acetate film was used as the spreading layer.

The multilayer analysis element was cut into rectangular chips measuring 12 mm×13 mm and the chips were accommodated in a slide frame (see JP Patent Publication (Kokai) No. 57-63452 A (1982)), thereby preparing a slide 2 for the analysis of ALT.

(9) Method of Preparing a Multilayer Analysis Element for the Analysis of ALT in which a Woven Fabric is Used as the Spreading Layer

Up to the preparation of the reagent layer, the procedure was the same as that (7) for the preparation of the multilayer analysis element for the analysis of ALT in which a polysulfone film was used as the spreading layer. Then after wetting the reagent layer by supplying water to the entire surface thereof at the supply volume of about 30 g/m², a broad cloth (to be hereinafter referred to as a woven fabric) prepared by using a yarn of polyethylene terephthalate corresponding to 60 denier was laminated under a slight pressure, dried and then adhered. Further, an aqueous solution which is the same as that (7) for the preparation of the multilayer analysis element for the analysis of ALT in which a polysulfone film was used as the spreading layer, was coated thereon, and dried thereby preparing a multilayer analysis element for the analysis of ALT in which a woven fabric was used as the spreading layer.

The multilayer analysis element was cut into rectangular chips measuring 12 mm×13 mm and the chips were accommodated in a slide frame (see JP Patent Publication (Kokai) No. 57-63452 A (1982)), thereby preparing a slide 3 for the analysis of ALT.

(10) Comparison of Sensitivity and Measurement Accuracy

10 μl each of water and a control serum with an alt activity of 841 U/L was spotted on the aforementioned slides 1, 2 and 3 for ALT analysis. Each slide was then incubated at 37° C., and the reflective optical density was measured at 650 nm from the support side. The change of reflective optical density 3 to 4 minutes after the spotting was then determined, and the sensitivity (the difference between the changes of reflective optical density when the control serum of 841 U/L was spotted and that when water was spotted (dODr (841 U/L-0 U/L))) was compared. Further, the accuracy (standard deviation <SD>g/dL) was compared when the 10 μL of the control serum was spotted with the ALT activity of 388 and 841 U/L. Table 6 shows the results of comparison of sensitivity, and Table 7 shows the results of comparison of accuracy.

TABLE 6
Result of sensitivity comparison

| | Sensitivity(dODr | Sensitivity |
|---|---|---|
| | (841 U/L-0 U/L)) | ratio |
| Slide 1 for ALT analysis | 0.240 | 1.39 |
| Slide 2 for ALT analysis | 0.228 | 1.32 |
| Slide 3 for ALT analysis | 0.173 | 1 |

TABLE 7
Result of accuracy (CV (%)) comparison

| ALT | | | |
|---|---|---|---|
| activity | Slide 1 for | Slide 2 for | Slide 3 for |
| (U/L) | ALT analysis | ALT analysis | ALT analysis |
| 388 | 1.2% | 0.9% | 2.2% |
| 841 | 1.1% | 1.1% | 3.3% |

The multilayer analysis element 1 for ALT analysis in which a PS film is used as the spreading layer and the multilayer analysis element 2 for ALT analysis in which a FM film is used as the spreading layer have better sensitivity than the multilayer analysis element 3 for ALT analysis in which a woven fabric is used as the spreading layer. The multilayer analysis element 1 and 2 also have an improved measurement accuracy.

### Example 3

### Comparison of Unevenness in the Reflected Light Amount when Different Materials for the Spreading Layer are used and Measurement Variations when the Photometry Area is Reduced

(1) Method of Preparing the Multilayer Analysis Element for Measuring the Reflected Light Amount in which a Polysulfone Film is used as the Spreading Layer

An aqueous solution (pH=5.1) with the following composition was coated to a clear and colorless smooth film of polyethylene terephthalate with a thickness of 180 μm and having a gelatin undercoat, in the following amounts of coating, and then dried to obtain a water-absorbing layer.

| | | |
|---|---|---|
| Gelatin | 16.6 | g/m² |
| Polyoxy(2-hydroxy)propylene nonylphenyl ether | 0.2 | g/m² |

Water was supplied to the entire surface of the reagent layer at the supply volume of about 15 g/m² to wet the reagent layer, and then a polysulfone film (SE-200: manufactured by Fuji Photo Film Co., Ltd.; to be hereafter referred to as a PS film) was laminated under a slight pressure, dried, and adhered. Thus a multilayer analysis element for the measurement of reflected light amount in which a polysulfone film was used as the spreading layer was prepared.

The multilayer analysis element was cut into rectangular chips measuring 12 mm×13 mm and accommodated in a slide frame (see JP Patent Publication (Kokai) No. 57-63452 A (1982)), thereby preparing a slide 1 for the analysis of reflection amount.

(2) Method of Preparing a Multilayer Analysis Element for Measuring Reflected Light Amount in which a Knitted Fabric is Used as the Spreading Layer

Up to the preparation of the reagent layer, the procedure was the same as that (1) for the preparation of the multilayer analysis element for measuring reflected light amount in which a polysulfone film was used as the spreading layer. Then, after wetting the reagent layer by supplying water to the entire surface of the reagent layer at the supply volume of about 30 g/m², a tricot-knitted fabric (to be hereinafter referred to as a knitted fabric) knitted at the 36 gauge with a yarn of polyethylene terephthalate corresponding to 50 denier was laminated under a slight pressure, dried and then adhered. Thus a multilayer analysis element for measuring reflected light amount in which a knitted fabric was used as the spreading layer was prepared.

The multilayer analysis element was cut into rectangular chips measuring 12 mm×13 mm and the chips were accommodated in a slide frame (see JP Patent Publication (Kokai) No. 57-63452 A (1982)), thereby preparing a slide 2 for measuring reflected light amount.

(3) Comparison of Unevenness in Reflected Light Amount

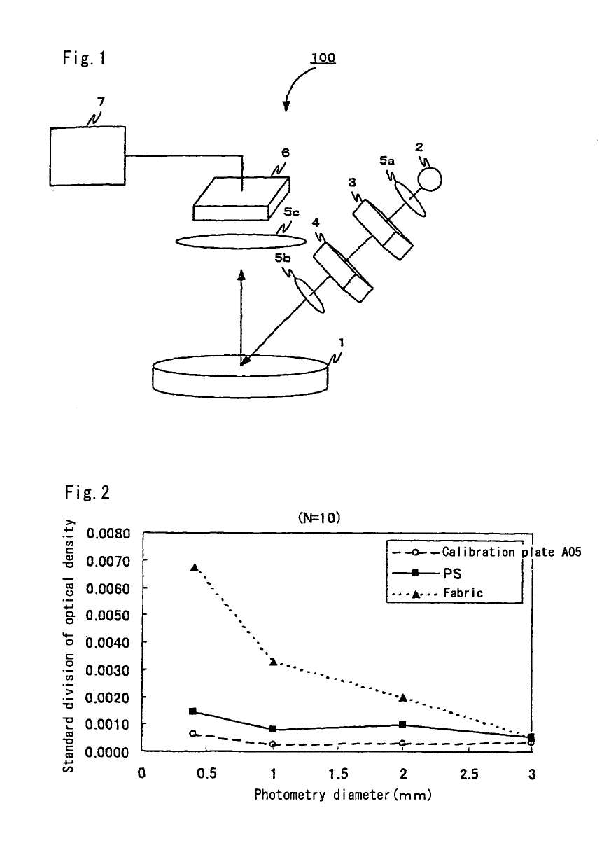

The slides 1 and 2 for measuring reflected light amount were measured from the support side, using a photometry system with an optical arrangement shown in FIG. 1. The variation coefficient (CV (%)) of reflective OD was compared when a photometry area with the diameter of 6 mm was measured by reflection photometry at 33 μm/pixel. The results are shown in Table 8.

Optical system: The optics of an inverted stereoscopic microscope were used. Magnification at the CCD photoreceiving unit was lx, or 10 μm/pixel at the CCD portion; and 0.33×, or 33 μm/pixel, at the CCD portion.

Light source: Luminar Ace LA-150UX manufactured by Hayashi Watch Works

Interference filter: monochromatized at 625 nm, 540 nm, and 505 nm
   Neutral density filter: ND-25 glass filter manufactured by Hoya Corporation, and a home-made filter consisting of a perforated stainless steel plate
   CCD: XC-7500 8-bit black-and-white camera module manufactured by Sony Corporation
   Data processing: Obtained images were processed and measured using an LUZEX-SE image processing apparatus manufactured by NIRECO Corporation.

As a means of calibrating the reflection optical density, density calibration plates (ceramic version) manufactured by Fuji Photo Equipment Co., Ltd. were used. Six types of the density calibration plates were used, namely: A00 (reflective optical density: approx. 0.05); A05 (approx. 0.5); A10 (approx. 1.0); A15 (approx. 1.5); A20 (approx. 2.0); and A30 (approx. 3.0).

TABLE 8
Comparison of the fluctuation coefficient (CV (%)) of reflective
OD when a photometry area with a diameter of 6 mm was measured
by reflective photometry at 33 μm/pixel

| | Slide 1 for | Slide 2 for |
|---|---|---|
| | measuring | measuring |
| | reflected | reflected |
| | light amount | light amount |
| Average value of | 0.296 | 0.391 |
| reflective OD | | |
| Standard deviation (SD) | 0.010 | 0.097 |
| Fluctuation coefficient | 3.4% | 25% |
| (CV (%)) | | |
| Maximum value | 0.333 | 0.771 |
| Minimum value | 0.260 | 0.275 |

IT was confirmed that the slide 2 for measuring reflected light amount in which a knitted fabric is used as the spreading layer has a very large CV of reflective OD due to the influence of the stitches, whereas the slide 1 for measuring reflected light amount using a PS film has a very small CV of reflective OD.

(3) Comparison of Measurement Variations when the Photometry Area was Reduced

The slides 1 and 2 for measuring reflected light amount were measured from the support side, using a photometry system with 10 μm/pixel and with an optical arrangement shown in FIG. 1, for the photometry areas ranging from 0.4 mm to 3 mm in diameter by repeating the putting in and out of n=10. The standard deviation (SD) of each photometry area was then compared. Similar measurement was conducted for the density calibration plate A05 as a comparative reference. The results are shown in Table 9 and in FIG. 2.

TABLE 9
Relationship between the standard deviation
(SD) of reflective OD and photometry area

| | Photometry diameter (mm) | | | |
|---|---|---|---|---|
| | 0.4 | 1 | 2 | 3 |
| Slide 1 for measuring | 0.00142 | 0.00079 | 0.00097 | 0.00056 |
| reflective light amount | | | | |
| Slide 2 for measuring | 0.00673 | 0.00327 | 0.00200 | 0.00053 |
| reflective light amount | | | | |
| Density calibration | 0.00061 | 0.00024 | 0.00029 | 0.00034 |
| plate A05 | | | | |

The standard deviation of reflective OD increases as the photometry area is reduced in the slide 2 for measuring reflective light amount in which a knitted fabric is used as the spreading layer. In contrast, in the slide 1 for measuring reflected light amount in which a PS film is used, the fluctuation in the standard deviation is small, so that a highly accurate measurement can be conducted even when the photometry area is reduced by a decrease in the volume of the liquid sample.

Effect of the Invention

In accordance with the multilayer analysis element of the invention, a liquid sample spreading layer comprises a non-fibrous porous film such that, after a liquid sample containing a target substance to be measured is caused to become attached to the surface of the liquid sample spreading layer, where it is spread and diffused, about 30% or more, and preferably about 60% or more of the target substance to be measured can be transferred to at least one functional layer beneath the liquid sample spreading layer. In this way, sensitivity can be improved and measurement accuracy can be increased, and furthermore the size of the analysis element can be reduced. The multilayer analysis element of the invention can be manufactured stably, and the intra-lot and lot-to-lot differences can be reduced.

1. A multilayer analysis element for the analysis of a liquid sample, comprising a water impermeable planar support on one side of which at least one functional layer and at least one porous liquid sample spreading layer of non-fibrous porous film are integrally laminated in the mentioned order, wherein said spreading layer comprises a non-fibrous porous film such that, when a liquid sample containing a target substance to be measured is caused to become attached to the surface of said liquid sample spreading layer, where said liquid sample is spread and dispersed, 30% or more of said target substance to be measured can be transferred to the at least one functional layer below said liquid sample spreading layer.

2. The multilayer analysis element for the analysis of a liquid sample according to claim 1, wherein said spreading layer comprises a non-fibrous porous film capable of transferring 60% or more of said target substance to be measured.

3. The multilayer analysis element for the analysis of a liquid sample according to claim 1, wherein said non-fibrous porous film comprises a porous film of an organic polymer.

4. The multilayer analysis element for the analysis of a liquid sample according to claim 3, wherein said porous film of an organic polymer is an asymmetric porous film with an asymmetry ratio of 2.0 or more.

5. The multilayer analysis element for the analysis of a liquid sample according to claim 3, wherein said porous film of an organic polymer is a symmetric porous film with an asymmetry ratio of less than 2.0.

6. The multilayer analysis element for the analysis of a liquid sample according to claim 3, wherein said porous film of an organic polymer is 6, 6-nylon; 6-nylon; acrylate copolymer; polyacrylate; polyacrylonitrile; polyacrylonitrile copolymer; polyamide, polyimide; polyamide-imide; polyurethane; polyether sulfone; polysulfone; a mixture of polyether sulfone and polysulfone; polyester; polyester carbonate; polyethylene; polyethylene chlorotrifluoroethylene copolymer; polyethylene tetrafluoroethylene copolymer; polyvinyl chloride; polyolefin; polycarbonate; polytetrafluoroethylene; polyvinylidene difluoride; polyphenylene sulfide; polyphenylene oxide; polyfluorocarbonate; polypropylene; polybenzoimidazole; polymethyl methacrylate; styrene-acrylonitrile copolymer; styrene-butadiene copolymer; a saponified product of ethylene-vinyl acetate copolymer; polyvinyl alcohol; cellulose acetate; a saponified product of cellulose acetate; cellulose acetate butyrate; a saponified product of cellulose acetate butyrate; or a mixture thereof.

7. The multilayer analysis element for the analysis of a liquid sample according to claim 3, wherein said porous film of an organic polymer is 6, 6-nylon; 6-nylon; polyether sulfone; polysulfone; a mixture of polyether sulfone and polysulfone; polyethylene; polypropylene; polyolefin; polyacrylonitrile; polyvinyl alcohol; polycarbonate; polyester carbonate; polyphenylene oxide; polyamide, polyimide; polyamide-imide; cellulose acetate; a saponified product of cellulose acetate; or a mixture thereof.

8. The multilayer analysis element for the analysis of a liquid sample according to claim 3, wherein said porous film of an organic polymer is polyethersulfone, polysulfone, cellulose acetate, a saponified product of cellulose acetate, or a mixture thereof.
